(19) United States
(12) Patent Application Publication
(10) Pub. No.: US 2005/0285999 A1
(43) Pub. Date: Dec. 29, 2005

(54) Liquid crystal display device and image display apparatus

(76) Inventor: Kikuo Kaise, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/217,041

(22) Filed: Aug. 31, 2005

Related U.S. Application Data
(62) Division of application No. 10/823,265, filed on Apr. 13, 2004.

(30) Foreign Application Priority Data
Apr. 15, 2003 (JP) P2003-110836

(51) Int. Cl. G02F 1/1335

(52) U.S. Cl. 349/117

(57) ABSTRACT

In an image display apparatus according to this invention, higher luminance of a displayed image can be realized by a microlens array provided in a liquid crystal display device. The influence of a pre-tilt of liquid crystal molecules in a liquid crystal panel is optically compensated by the optical compensation layer. Higher contrast of the displayed image and a longer life of the apparatus are thus realized. Since a highly light-resistant inorganic material is used for the optical compensation layer, higher luminance of the displayed image can be realized by higher output of a light source of the image display apparatus. Specifically, if sapphire or crystal, which is highly thermally conductive, is used as the inorganic material, rise in the temperature of the liquid crystal display device can be restrained.

### BACKGROUND OF THE INVENTION

1. Field of the Invention

This invention relates to an image display apparatus using a liquid crystal display device as a spatial light modulator.

This application claims priority of Japanese Patent Application No. 2003-110836, filed on Apr. 15, 2003, the entirety of which is incorporated by reference herein.

2. Description of the Related Art

An image display apparatus using a liquid crystal display device as a spatial light modulator has an illuminating optical system and an image-forming optical system for forming an image of the liquid crystal display device on a screen.

In such an image display apparatus, higher contrast and higher luminance of displayed images are demanded. It is also demanded that the apparatus has a longer life. In such a liquid crystal display device, a microlens array for condensing an incident luminous flux on an effective display area part of the liquid crystal display device is provided to realize higher luminance of displayed images.

Patent Reference: JP-A-2001-343623

As the above-described liquid crystal display device, so-called TN (twisted nematic) liquid crystal is broadly used. In the image display apparatus using this TN liquid crystal, the influence of pre-tilt of liquid crystal molecules on the interface between a liquid crystal layer and a board of the liquid crystal display device causes occurrence of a so-called “black prominence” phenomenon that a part where black should be displayed has lightness at the time of voltage application (black display) to the liquid crystal device, and therefore the contrast is lowered. Particularly when a microlens array is provided on the luminous flux incidence side of the liquid crystal display device, such as “black prominence” phenomenon appears markedly.

Measures to prevent such a phenomenon are proposed such as arrangement of a broader visual angle film made of discotic liquid crystal (for example, “WV film” (trade name) of Fuji Photo Film) as described in Patent Reference 1, near the liquid crystal display, and arrangement of a uniaxial phase-difference film in an inclined state near the liquid crystal display device. As the broader visual angle film or uniaxial phase-difference film compensates double refraction due to the pre-tilt angle of the liquid crystal molecules, higher contrast of displayed images is realized.

However, in the case where the broader visual angle film made of discotic liquid crystal is used, there is a problem about the life of this broader visual angle film. Specifically, the life of the broader visual angle film is not long enough to correspond to the life of the image display apparatus, which is assumed to be several thousands hours. If the output of the light source is increased to realize higher luminance of display images, the life of the broader visual angle film becomes much shorter.

On the other hand, if the uniaxial phase-difference film is installed in an inclined state near the liquid crystal display device, a large space is needed for installing the uniaxial phase-difference film and the structure of the image display apparatus is increased in size.

### SUMMARY OF THE INVENTION

Thus, in view of the foregoing status of the art, it is an object of this invention to provide a liquid crystal display device that does not increase the size of the structure of an image display apparatus when it is used as a spatial light modulator in the image display apparatus and that can realize higher contrast of display images while maintaining a sufficiently long life, and an image display apparatus using such a liquid crystal display device.

To solve the above-described problems, a liquid crystal display device according to this invention is a liquid crystal display device having a microlens array provided on a luminous flux incidence side, and the liquid crystal display device has an optical compensation layer made of an inorganic material and having an optical axis inclined with respect to a liquid crystal panel surface, at least on one of a luminous flux incidence side and a luminous flux emission side of the liquid crystal panel.

Moreover, another liquid crystal display device according to this invention has a microlens array provided on a luminous flux incidence side. The liquid crystal display device has two optical compensation layers made of an inorganic material and having an optical axis inclined with respect to a liquid crystal panel surface, on a luminous flux incidence side of the liquid crystal panel.

As these liquid crystal display devices according to this invention are used as a spatial light modulator in an image display apparatus, higher luminance of displayed images can be realized by the microlens array. In addition to this, the influence of a pre-tilt of liquid crystal molecules in a liquid crystal panel can be optically compensated by the optical compensation layer(s), thus realizing higher contrast of displayed images and a longer life. Moreover, since the inorganic material having high light resistance is used for the optical compensation layer(s), higher luminance of displayed images due to higher output of a light source of the image display apparatus can be realized. If sapphire or crystal, both of which are highly thermally conductive, is used as the inorganic material, rise in the temperature of the liquid crystal panel can be restrained.

An image display apparatus according to this invention has a light source, a liquid crystal display device having a microlens array provided on a luminous flux incidence side as a spatial light modulator, an illuminating optical system for guiding a luminous flux emitted from a light source to the liquid crystal display device and thus illuminating the liquid crystal display device, and an image-forming lens for forming an image of the liquid crystal display device. The liquid crystal display device has an optical compensation layer made of an inorganic material and having an optical axis inclined with respect to a liquid crystal panel surface, at least on one of a luminous flux incidence side and a luminous flux emission side of the liquid crystal panel.

Another image display apparatus according to this invention has a liquid crystal display device having two optical compensation layers made of an inorganic material and having an optical axis inclined with respect to a liquid crystal panel surface, on a luminous flux incidence side of the liquid crystal panel.

In these image display apparatuses according to this invention, higher luminance of displayed images can be realized by the microlens array provided in the liquid crystal display device, and the influence of a pre-tilt of liquid crystal molecules in the liquid crystal panel is optically compensated by the optical compensation layer(s). Higher contrast of display images is realized and also a longer life is realized. Moreover, since the inorganic material having high light resistance is used for the optical compensation layer(s), higher luminance of displayed images due to higher output of the light source of the image display apparatus can be realized. If sapphire or crystal, both of which are highly thermally conductive, is used as the inorganic material, rise in the temperature of the liquid crystal display device can be restrained.

### BRIEF DESCRIPTION OF THE DRAWINGS

FIG. 1 is a side view showing a structure of a liquid crystal display device according to this invention.

FIG. 2 is a sectional view showing the structure of the liquid crystal display device.

FIG. 3 is a graph showing transmittance ratio in the liquid crystal display device.

FIG. 4 is a graph showing transmittance ratio in the case where the order of optical compensation plates is changed in the liquid crystal display device.

FIG. 5 is a side view showing another exemplary structure of the liquid crystal display device.

FIG. 6 is a graph showing transmittance ratio in the case where the thickness of an optical compensation plate is changed in the liquid crystal display device.

FIG. 7 is a side view showing the relation between the optical axis of the optical compensation plate in the liquid crystal display device and the optical axis of a liquid crystal panel (in the case where Δn has different signs).

FIG. 8 is a side view showing the relation between the optical axis of the optical compensation plate in the liquid crystal display device and the optical axis of the liquid crystal panel (in the case where Δn has the same sign).

FIG. 9 is a flowchart showing a process of preparing the optical compensation plate of the liquid crystal display device.

FIGS. 10A to 10C are perspective views showing the process of preparing the optical compensation plate of the liquid crystal display device.

FIGS. 11A and 11B are perspective views showing arrangement states of optical compensation plate of the liquid crystal display device.

FIG. 12 is a perspective view showing the appearance of the liquid crystal display device.

FIG. 13 is a plan view showing the structure of an image display apparatus according to this invention.

FIG. 14 is graphs showing the effects of the optical compensation plate of the liquid crystal display device in the image display apparatus.

FIG. 15 is a longitudinal sectional view showing a process of preparing a microlens array in the liquid crystal display device.

FIG. 16 is graphs showing the effects of the optical compensation plate (provided over the microlens array) of the liquid crystal display device in the image display apparatus.

FIG. 17 is a longitudinal section view showing a structure of the microlens array in the liquid crystal display device.

FIG. 18 is a longitudinal sectional view showing a structure in which the optical compensation plate is provided over the microlens array in the liquid crystal display device.

FIG. 19 is graphs showing the effects of the optical compensation plate of the liquid crystal display device in the image display apparatus (with a 14-μcm pixel pitch and 0.7-inch panel).

FIG. 20 is graphs showing the effects of the optical compensation plate of the liquid crystal display device in the image display apparatus (with a 11-μm pixel pitch and 0.55-inch panel).

### DESCRIPTION OF THE PREFERRED EMBODIMENTS

Embodiments of this invention will now be described with reference to the drawings.

[Structure of Liquid Crystal Display Device]

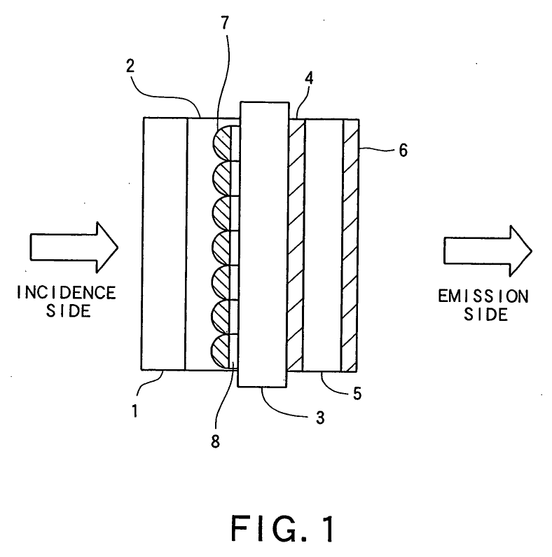

In a liquid crystal display device according to this invention, an incidence-ide dustproof glass 1 (made of quartz with a thickness of 1.0 mm), a microlens board 2 (made of quartz with a thickness of 1.0 mm), and a TFT board 3 (made of quartz with a thickness of 1.1 mm) are sequentially stacked from the luminous flux incidence side, and a first optical compensation plate 4 (made of sapphire) to be an optical compensation layer for optically compensating an emission-side pre-tilt component, an emission-side dustproof glass 5 (made of quartz with a thickness of 1.0 mm), and a second optical compensation plate 6 (made of sapphire) for optically compensating an incidence-side pre-tilt component are sequentially stacked toward the luminous flux emission side, as shown in FIG. 1.

A microlens array 7 is formed on the TFT board 3 side of the microlens board 2. A liquid crystal panel formed by sealing liquid crystal molecules is arranged within the TFT board 3. A major surface of the liquid crystal panel on the luminous flux incidence side faces the microlens array 7, as a liquid crystal panel surface 8.

The first optical compensation plate 4 is for compensating the optical influence of the pre-tilt angle of liquid crystal molecules on the luminous flux emission side of the liquid crystal panel. The second optical compensation plate 6 is for compensating the optical influence of the pre-tilt angle of liquid crystal molecules on the luminous flux incidence side of the liquid crystal panel. Whether these optical compensation plates 4, 6 are arranged on the luminous flux incidence side or the luminous flux emission side of the liquid crystal panel, and in whatever order, the optical compensation plates 4, 6 have an effect of improving contrast of a displayed image in an image display apparatus, which will be described later.

Each of the optical compensation plates 4, 6 is made of uniaxial crystal such as crystal or sapphire and formed in a flat plate-like shape. Each of the optical compensation plates 4, 6 has its optical axis inclined with respect to the liquid crystal panel surface 8. The direction of projection onto the liquid crystal panel surface 8 of the direction of the optical axis of each of the optical compensation plates 4, 6 is substantially parallel to at least either the direction of projection onto the liquid crystal panel surface 8 of the direction of pre-tilt of liquid crystal molecules near the board surface on the luminous flux incidence side of the liquid crystal panel or the direction of projection onto the liquid crystal panel surface 8 of the direction of pre-tilt of liquid crystal molecules near the board surface on the luminous flux emission side of the liquid crystal panel.

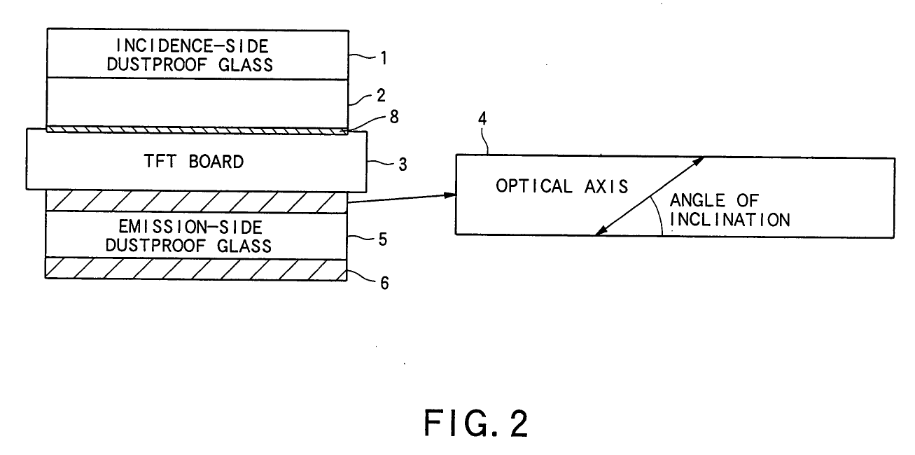

The optimum angle of inclination of the optical axes of the optical compensation plates 4, 6 with respect to the liquid crystal panel surface 8 can be found by simulating transmittance at the time of voltage application (so-called “black display”) to the liquid crystal panel. This simulation can be performed, for example, using a liquid crystal simulator “LCD Master” (trade name) made by SHINTEC INC. The angle of inclination of the optical axes of the optical compensation plates 4, 6 with respect to the liquid crystal panel surface 8 is defined so that the direction along (parallel to) the liquid crystal panel surface is at 0° , as shown in FIG. 2.

The simulation was performed using dielectric constants (ε11, ε22, ε33), elastic constants (K11, K22, K33), rotational viscosity, helical pitch, pre-tilt angle on an orientation film surface, liquid crystal cell gap, and twist angle based on a liquid crystal material “MJ99200” (trade name) made by “Merck Ltd.”. Liquid crystal director distribution at the time of applying a predetermined voltage was calculated. On the basis of the distribution, the ordinary ray refractive index (no) and extraordinary ray refractive index (ne) of the liquid crystal, and the ordinary ray refractive index (no) and extraordinary ray refractive index (ne) of sapphire as the characteristics of the optical compensation plates were used. The thickness of the optical compensation plates was 20 μm. Both the optical compensation plates 4, 6 were arranged on the luminous flux emission side of the liquid crystal panel, as shown in FIG. 1.

Then, using an optical model formed by combining the liquid crystal display device and a polarizing plate, the incident angle dependence of the transmittance of a propagating ray with a wavelength of 550 nm was found by a 4×4 matrix technique.

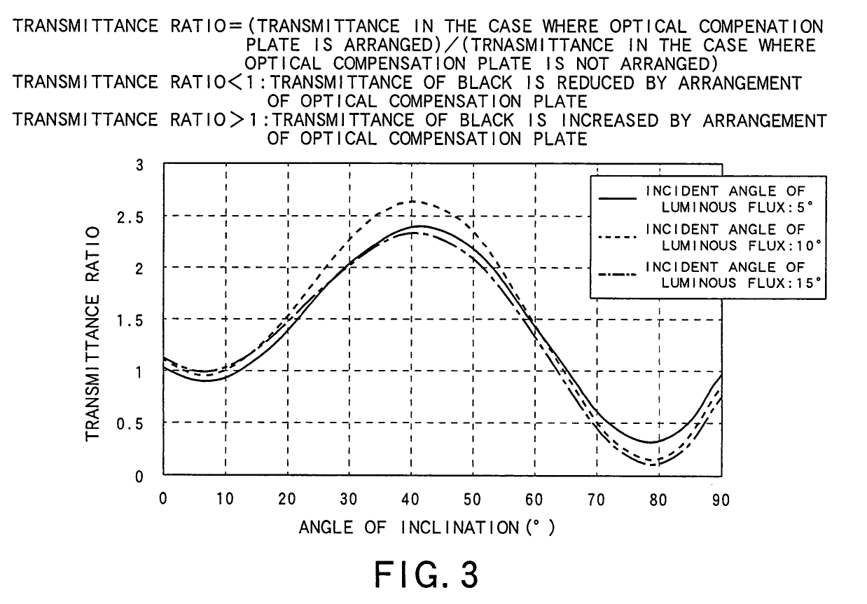

For the transmittance, on the assumption that the incidence angle of a luminous flux was 5°, 10° and 15°, the direction of the optical axes of the optical compensation plates was equally divided every 5° into 72 directions with reference to the rubbing direction on the luminous flux incidence side of the liquid crystal panel, and the average transmittance thereof was regarded as the transmittance at each incident angle. As shown in FIG. 3, the ratio of transmittance in “black display” between the case of using only the liquid crystal panel and the case of arranging the optical compensation plates was found.

By optimizing the angle of inclination of the optical axes of the optical compensation plates with respect to the liquid crystal panel surface 8 on the basis of this result, it is possible to sufficiently reduce the transmittance in “black display”. As shown in FIG. 3, an optimum angle of inclination of the optical axes of the optical compensation plates is approximately 75° to 85°.

In this liquid crystal display device, since the microlens array is arranged on the luminous flux incidence side of the liquid crystal panel, the incident angle of the luminous flux to the liquid crystal panel is different from the emission angle of the luminous flux from the liquid crystal panel and therefore the above-described simulation conditions are slightly different from the conditions in the actual optical system. However, in the image display apparatus using the liquid crystal display device, since the incident angle of the luminous flux to the liquid crystal panel is approximately 13° to 14°, the difference in the optimum angle of the optical axes of the optical compensation plates caused by the difference between the above-described simulation conditions and the conditions in the actual optical system is small. Therefore, as the two optical compensation plates 4, 6 having the inclined optical axes are arranged as described above, the contrast of a displayed image is improved.

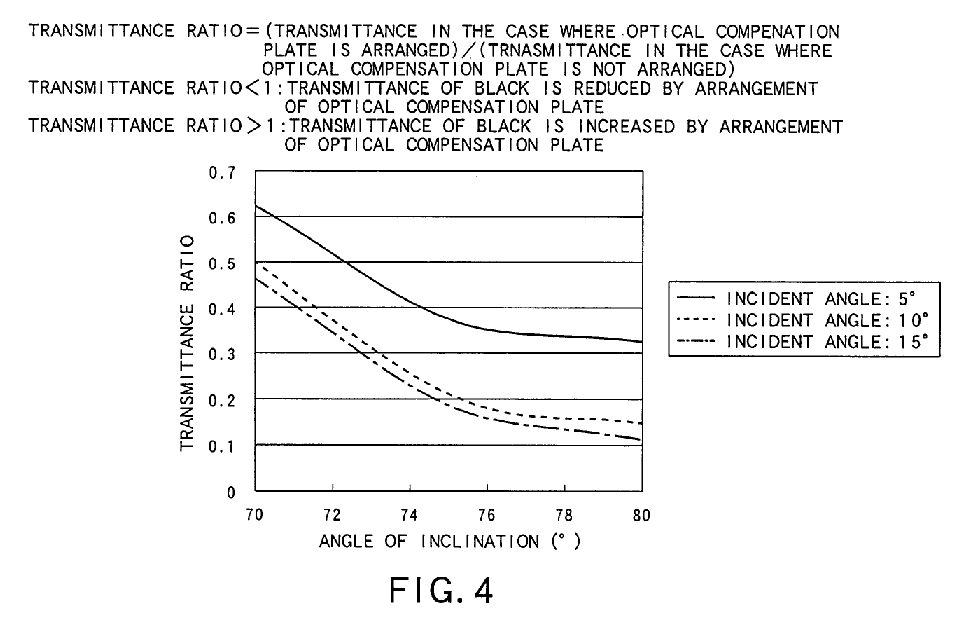

Also in the case where the arrangement positions of the two optical compensation plates 4, 6 are replaced with each other, it is possible to reduce the transmittance in “black display” by setting the optical axes at the optimum angle of inclination, as shown in FIG. 4.

From these results, it was found that the two optical compensation plates 4, 6 can improve the contrast of a displayed image if they are arranged to optically compensate the pre-tilt component on the luminous flux incidence side of the liquid crystal panel and the pre-tilt component on the luminous flux emission side, irrespective of their arrangement order.

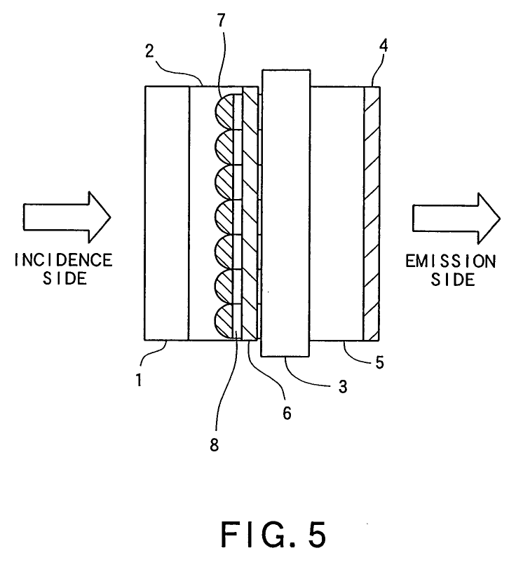

That is, one of the two optical compensation plates 4, 6 may be arranged on the luminous flux incidence side of the liquid crystal panel and the other may be arranged on the luminous flux emission side, as shown in FIG. 5. The optical compensation plates 4, 6 may be formed on the major surfaces of the incidence-side dust proof glass 1 and the emission-side dustproof glass 5, or may be formed as the microlens board 2 (cover glass of the microlens array).

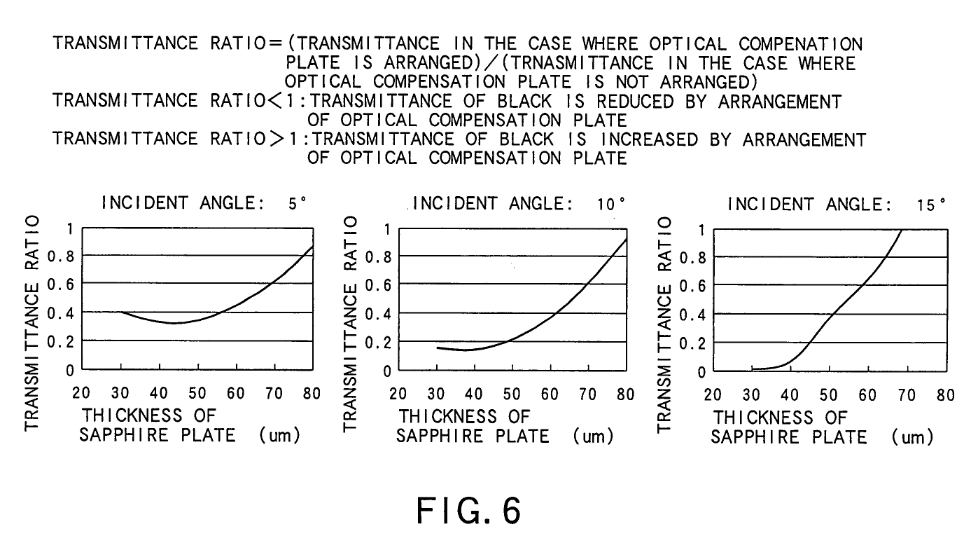

Now, in the case where the optical compensation plates are made of sapphire, the transmittance ratio in “black display” when changing the thickness of the optical compensation plates from 20 to 80 μm is sufficiently restrained even when the thickness is 80 μm if the incident angle to the liquid crystal panel is 5°, as shown in FIG. 6. The transmittance ratio represented by the vertical axis in FIG. 6 is the ratio of the transmittance in the case where the optical compensation plates are arranged to the transmittance in the case where the optical compensation plates are not arranged. If the transmittance ratio is less than 1, it means that the transmittance is reduced by the arrangement of the optical compensation plates and that the contrast of the displayed image is improved. The angle of inclination of the optical axes of the optical compensation plates in this case is 80°.

An absolute value Δn of refractive index anisotropy of sapphire is substantially 0.008 in each wavelength range. When the thickness d of the sapphire plates is 80 μm, Δn*d is approximately 640 nm. If Δn*d is more than 640 nm with respect to the optical compensation plates, double refraction by the optical compensation plates becomes dominant in the transmittance of “black display”. The transmittance increases, causing a “black prominence” phenomenon. From this result, it is desired that Δn*d is equal to or less than 640 nm with respect to one optical compensation plate.

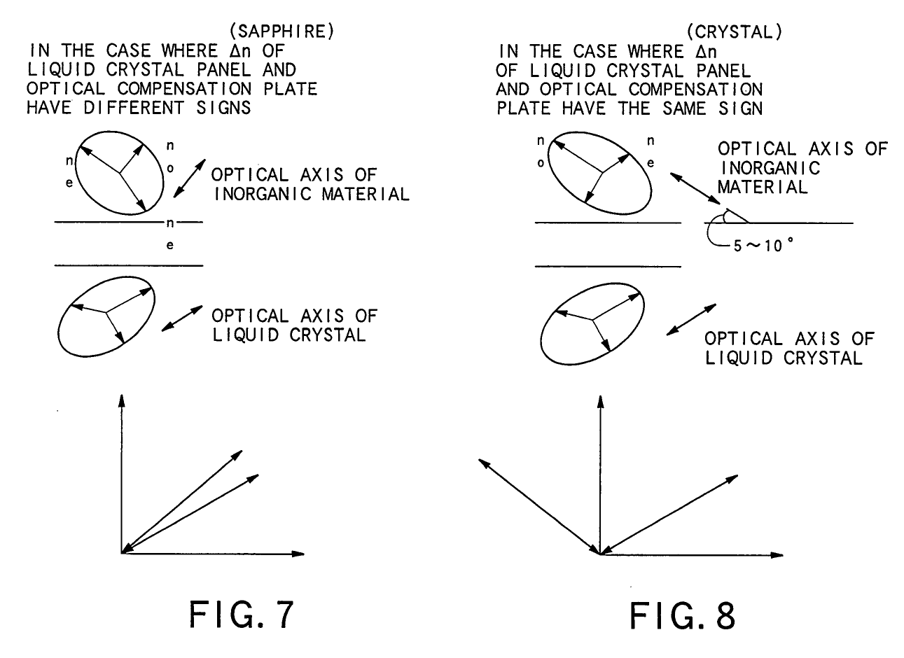

In the case where the refractive index anisotropy of the optical compensation plates and the refractive index anisotropy of the liquid crystal layer of the liquid crystal panel have difference signs, as in the case where the optical compensation plates are made of sapphire, the optical axes of the optical compensation plates and the optical axis of the liquid crystal layer should be inclined in the same direction with respect to the liquid crystal panel surface, as shown in FIG. 7.

On the other hand, in the case where the refractive index anisotropy of the optical compensation plates and the refractive index anisotropy of the liquid crystal layer of the liquid crystal panel have the same sign, as in the case where the optical compensation plates are made of crystal, the optical axes of the optical compensation plates and the optical axis of the liquid crystal layer should be inclined in the opposite directions with respect to the liquid crystal panel surface, as shown in FIG. 8.

[Preparation of Liquid Crystal Display Device (1)]

A method for preparing the liquid crystal display device according to this invention will now be described.

First, a liquid crystal panel of a predetermined standard, for example, the following standard, is prepared by arranging a microlens array on the incidence side. Specifically, a liquid crystal cell of the “XGA” standard having an effective pixel size (diagonal line) of 0.9 inches and a pixel pitch of 18 μm is prepared. The liquid crystal cell is prepared by carrying out application of an orientation film, rubbing processing, and arrangement of a spacer at a rubbing angle of 90°, a twist angle of 90° and with a cell gap of 3.2 μm. Liquid crystal (“MJ99200” (trade name) made by Merck Ltd.) is injected therein to complete the liquid crystal cell.

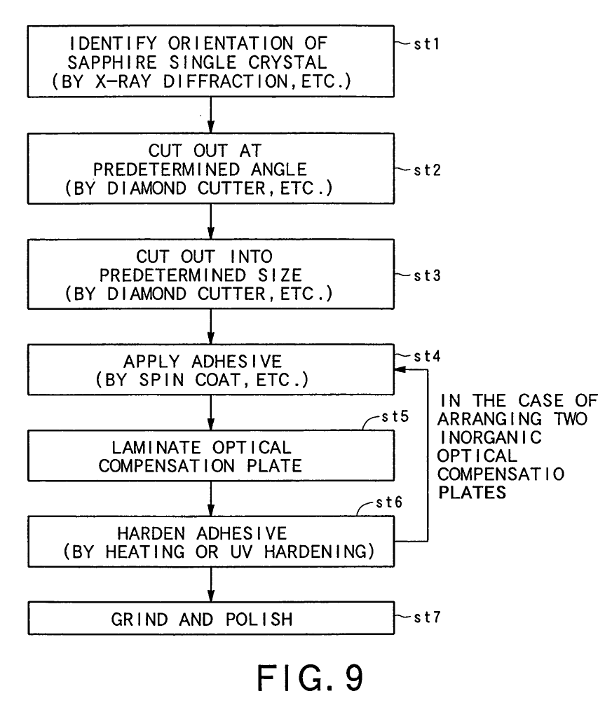

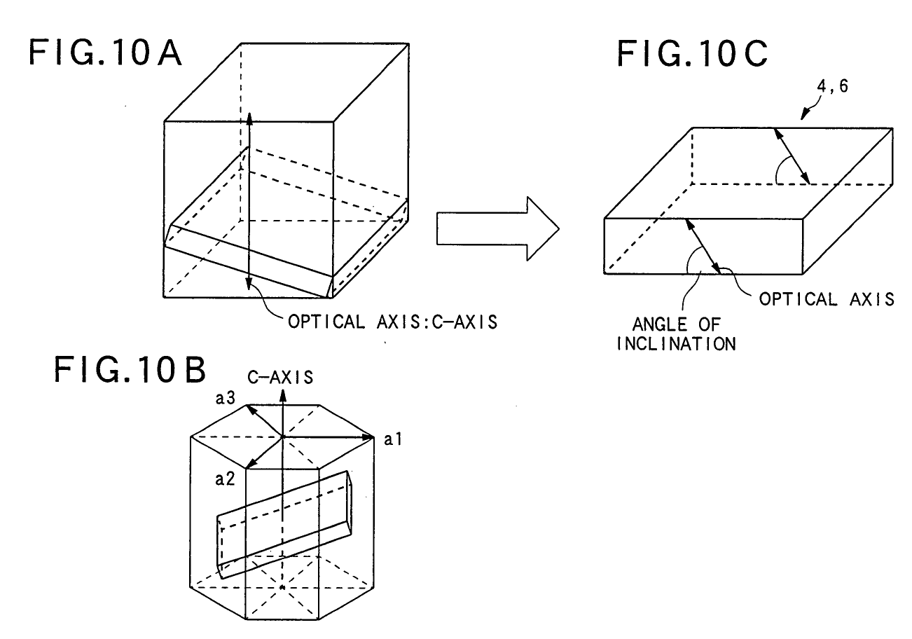

Next, for preparing an optical compensation plate, first at step st1 as shown in the flowchart of FIG. 9, the crystal orientation is identified, for example, by X-ray diffraction with respect to a sapphire single-crystal block as shown in FIGS. 10A and 10B. Next, at step st2 in FIG. 9, a sapphire plate is cut out by using a diamond cutter so that the angle of inclination of its optical axis to the surface of the sapphire single-crystal block becomes 60°, 70°, 80°, and 90°, as shown in FIG. 10C. Then, at step st3 in FIG. 9, a sapphire plate having a predetermined thickness and size is cut out by using the diamond cutter.

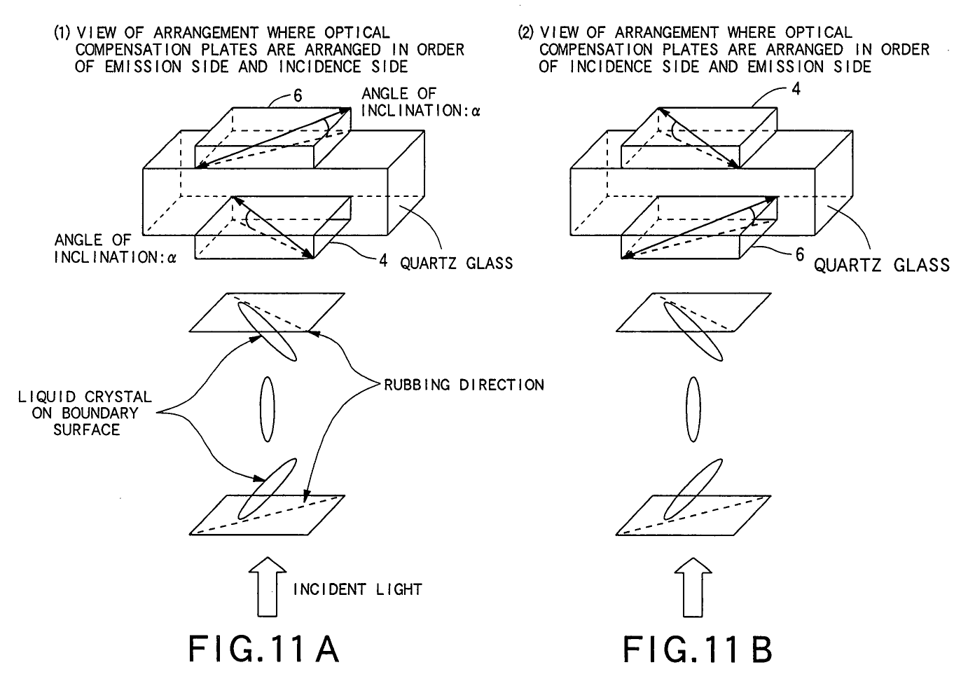

In this case, a sapphire plate having a thickness of approximately 25 μm is cut out. Moreover, in this case, the direction of inclination of the optical axis with respect to the rectangular glass shape is caused to coincide with the rubbing direction of the liquid crystal panel so that a pre-tilt component in the liquid crystal panel can be optically compensated, as shown in FIGS. 11A and 11B. The optical compensation plate cut out in this case has a size large enough to cover the effective pixels of the liquid crystal panel.

At step st4 in FIG. 9, an adhesive is applied onto the surface of a quartz glass, which is a dustproof glass or the like, by so-called spin coat technique in a reduced-pressure chamber. As the adhesive, for example, silicon resin, epoxy resin, acrylic resin, or fluororesin is applied.

Next, at step st5, the optical compensation plate is laminated to the predetermined dustproof glass or the like in a predetermined direction. At step st6, the adhesive is hardened. The adhesive is hardened by heating or by casting ultraviolet (UV) rays. If two optical compensation plates are used, these steps st4 to st6 are carried out twice. At step st7, the sapphire plate is ground and polished to a thickness of 20 μm. The dustproof glass with the optical compensation plate arranged thereon is thus prepared.

In FIG. 11A, the first optical compensation plate 4 for compensating a pre-tilt on the emission side of the liquid crystal panel is arranged on the luminous flux incidence side, and the second optical compensation plate 6 for compensating a pre-tilt on the incidence side of the liquid crystal panel is arranged on the luminous flux emission side. In FIG. 11B, the second optical compensation plate 6 for compensating a pre-tilt on the incidence side of the liquid crystal panel is arranged on the luminous flux incidence side, and the first optical compensation plate 4 for compensating a pre-tilt on the emission side of the liquid crystal panel is arranged on the luminous flux emission side.

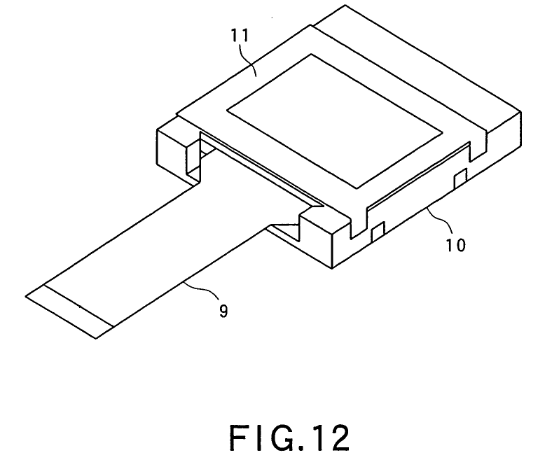

After that, a dustproof glass having no optical compensation plate arranged thereon is attached to the luminous flux incidence side. On the luminous flux emission side, a dustproof glass having no optical compensation plate arranged thereon and the dustproof glass having the optical compensation plate arranged thereon are arranged in a predetermined direction as shown in FIGS. 11A and 11B. Moreover, a flexible board 9 to be connected to the TFT board is attached and, for example, a metal frame 10 is fit thereon and a finishing plate 11 is attached, as shown in FIG. 12. The liquid crystal display device that can be used in the image display apparatus is thus completed.

[Measurement of Contrast in Displayed Image on Image Display Apparatus]

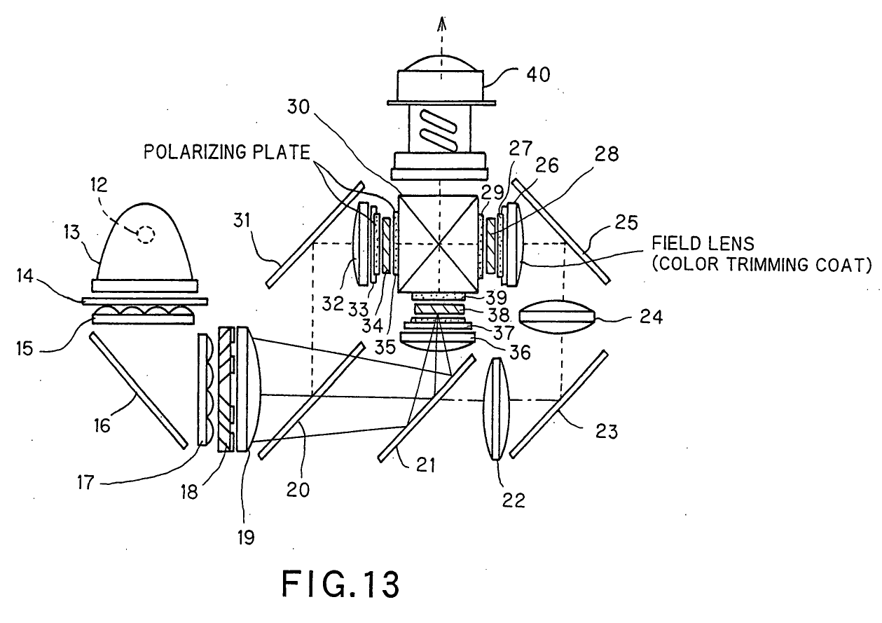

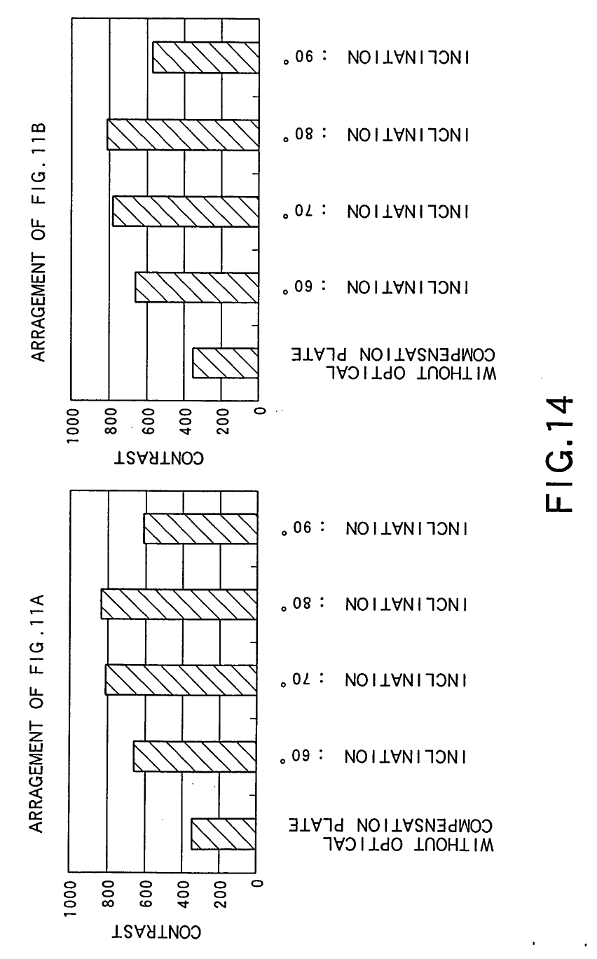

The image display apparatus according to this invention using the liquid crystal display device as described above has a light source 12 such as a discharge lamp, as shown in FIG. 13. Luminous fluxes emitted from the light source 12 are reflected by a concave mirror (parabolic mirror) 13 to be substantially parallel luminous fluxes, then transmitted through a UV (ultraviolet)/IR (infrared) cut filter 14 and a first fly-eye lens array 15, then reflected by a mirror 16 and become incident on a second fly-eye lens array 17. As the luminous fluxes having substantially uniform lightness by being transmitted through the first and second fly-eye lens arrays 15 and 17 are transmitted through a PS combination device 18, the luminous fluxes have a predetermined direction of polarization.

The PS combination device 18 has plural polarized light separation films parallel to each other. P-polarized components of the incident luminous fluxes on the PS combination device 18 are transmitted through the polarized light separation films. S-polarized components of the incident luminous fluxes on the PS combination device 18 are reflected twice by the polarized light separation films and then emitted. These P-polarized component and S-polarized components are emitted parallel to each other but their emitting positions are separated. A half-wavelength (λ/2) plate is arranged at either the emitting position of the P-polarized components or the emitting position of the S-polarized components to rotate the direction of polarization by 90°. In this manner, the emitted luminous fluxes from the PS combination device 18 have the same direction of polarization.

The emitted light from the PS combination device 18 is transmitted through a condenser lens 19 and becomes incident on a first dichroic mirror 20. The first dichroic mirror 20 reflects one of the three primary colors (R, G, B) and transmits the other two colors.

The luminous fluxes transmitted through the first dichroic mirror 20 become incident on a second dichroic mirror 21. The second dichroic mirror 21 reflects one of the two primary colors transmitted through the first dichroic mirror 20 and transmits the remaining one color (first color).

The luminous flux transmitted through the second dichroic mirror 21 is transmitted through a relay lens 22, a mirror 23, a relay lens 24 and a mirror 25 and then through a field lens 26 and a polarizing plate 27, and becomes incident on a first liquid crystal display device 28. This luminous flux has its polarization modulated in accordance with the first color component of the displayed image by the first liquid crystal display device 28 and is then transmitted. The luminous flux is transmitted through a polarizing plate 29 and becomes incident on a cross prism 30 form its one lateral side.

The luminous flux of the one color (second color) reflected by the second dichroic mirror 21 is transmitted through a field lens 26 and a polarizing plate 37 and becomes incident on a second liquid crystal display device 38. This luminous flux has its polarization modulated in accordance with the second color component of the displayed image by the second liquid crystal display device 38 and is then transmitted. The luminous flux is transmitted through a polarizing plate 39 and becomes incident on the cross prism 30 from its rear side.

The luminous flux of the one color (third color) reflected by the first dichroic mirror 20 is transmitted through a mirror 31, then through a field lens 32 and a polarizing plate 33, and becomes incident on a third liquid crystal display device 34. This luminous flux has its polarization modulation in accordance with the third color component of the displayed image by the third liquid crystal display device 34 and is then transmitted. The luminous flux is transmitted through a polarizing plate 35 and becomes incident on the cross prism 30 from its other lateral side.

The luminous fluxes of the three primary colors incident on the cross prism 30 from the three sides are combined by this cross prism 30 and become incident on an image forming (projection) lens 40, which is an image-forming optical system. The image forming lens 40 projects the incident luminous flux on a screen, not shown, to display an image.

In such an image display apparatus, the contrast of the image projected on the screen is measured in the case where the liquid crystal display devices have optical compensation plates and in the case where the liquid crystal display devices do not have optical compensation plates. As shown in FIG. 14, the contrast of the displayed image is improved in the case where the optical compensation plates are provided, compared with the case where the optical compensation plates are not provided. In the image display apparatus that acquired this result, the F-value of the image forming lens of the optical system is 2.5.

[Preparation of Liquid Crystal Display Device (2)]

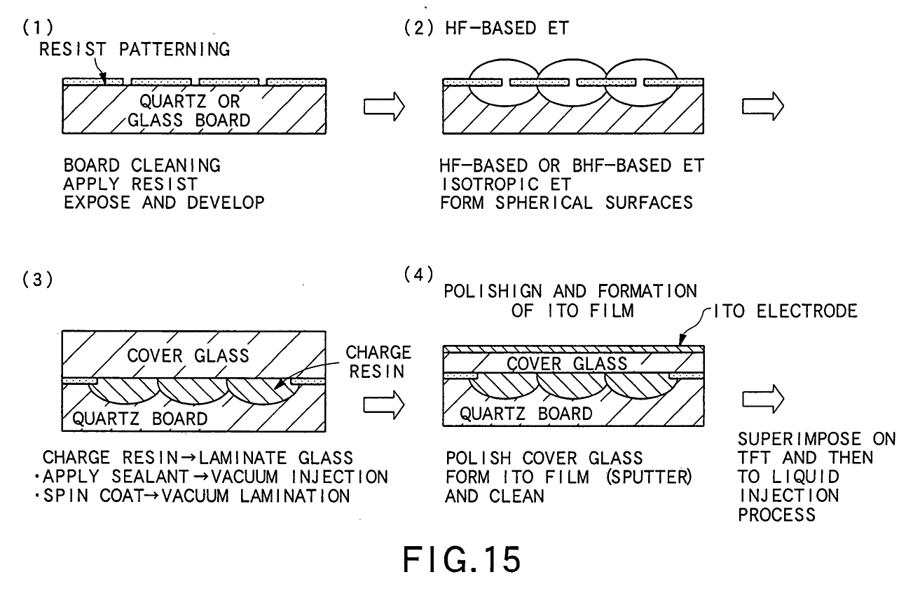

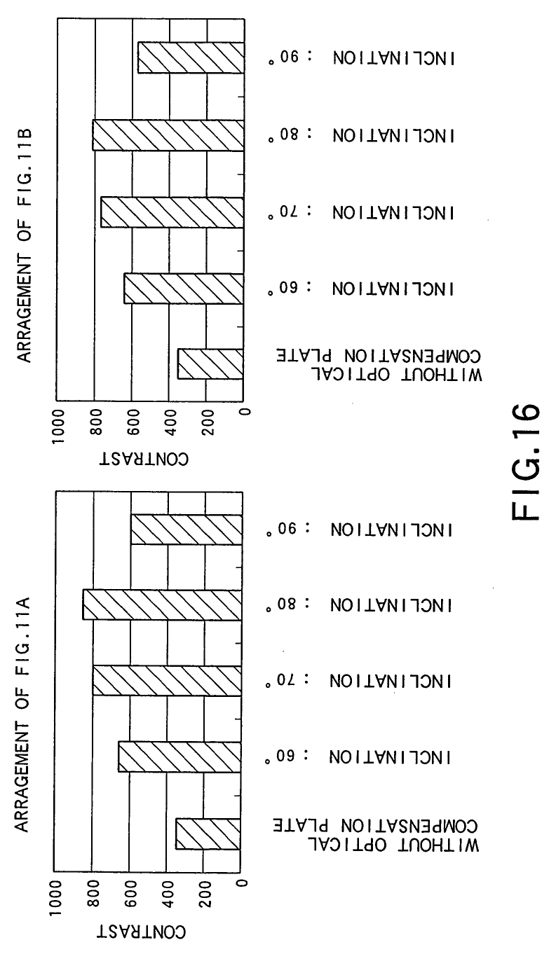

In this liquid crystal display device, a microlens array can be prepared by process steps (1) to (4) shown in FIG. 15.

At the process step (1), quartz having a thickness of 1.5 mm is used as a substrate and the substrate is cleaned, for example, by an RCA cleaning technique. After that, a resist is applied corresponding to each pixel and exposure and development are performed. A resist mask that opens the center of each pixel in an appropriate shape is thus prepared.

At the process step (2), for example, using HF or BHF, isotropic etching is performed to form spherical surfaces on the quartz substrate. The diameter of the spherical surface is made substantially equal to the pixel size, and the spacing between the centers of the spherical surfaces is made equal to the pixel pitch.

At the process step (3), a resin having a refractive index that is different from the refractive index of the quartz is applied and then extended by a spin coat technique. A microlens array is thus prepared. As a cover glass, an optical compensation plate having a thickness greater than a predetermined thickness is prepared by the above-described process of FIG. 9. The angle of inclination of its optical axis set at 60°, 70°, 80° and 90°. The sapphire board has a thickness of approximately 25 μm.

The optical compensation plate is arranged at a position where it can optically compensate a pre-tilt component on the incidence side, and the optical compensation plate is attached to the microlens array. After that, the quartz glass and the sapphire plate are ground and polished to a predetermined thickness. In this case, the sapphire plate is ground and polished to a thickness of 20 μm.

In the process step (4), an ITO film is formed on the cover glass by a sputtering technique, thus preparing a microlens board.

In the liquid crystal panel, the microlens array is arranged on the incidence side, as in the above-described case. The liquid crystal panel is prepared, for example, in accordance with the following predetermined standard. Specifically, a liquid crystal cell of “XGA” standard having an effective pixel size (diagonal line) of 0.9 inches and a pixel pitch of 18 μm is prepared. Application of an orientation film, rubbing processing, and arrangement of a spacer are carried out at a rubbing angle of 90°, a twist angle of 90° and a cell gap of 3.2 μm, and liquid crystal (“MJ99200” (trade name) made by Merck Ltd.) is injected. The liquid crystal cell is thus completed.

In this manner, the liquid crystal display device is completed as shown in FIG. 5. Each optical compensation plate is arranged in such a manner that the angle of inclination of the optical axis of the optical compensation plate on the luminous flux incidence side is equal to the angle of inclination of the optical axis of the optical compensation plate on the luminous flux emission side. In this case, the angle of inclination of the optical axis of the optical compensation plate for compensating a pre-tilt component on the luminous flux incidence side need not be coincident with the angle of inclination of the optical axis of the optical compensation plate for compensating a pre-tilt component on the luminous flux emission side.

Moreover, the flexible board 9 to be connected to the TFT board is attached and, for example, the metal frame 10 is fit thereon and the finishing plate 11 is attached, as shown in FIG. 12. The liquid crystal display device that can be used in the image display apparatus is thus completed.

For the liquid crystal display device formed as described above, the contrast of the image projected on the screen is measured in the case where the liquid crystal display devices have optical compensation plates and in the case where the liquid crystal display devices do not have optical compensation plates, using the optical system of the image display apparatus described with reference to FIG. 13. As shown in FIG. 16, the contrast of the displayed image is improved in the case where the optical compensation plates are provided, compared with the case where the optical compensation plates are not provided. In the image display apparatus that acquired this result, the F-value of the image forming lens of the optical system is 2.5.

[Preparation of Liquid Crystal Display Device (3)]

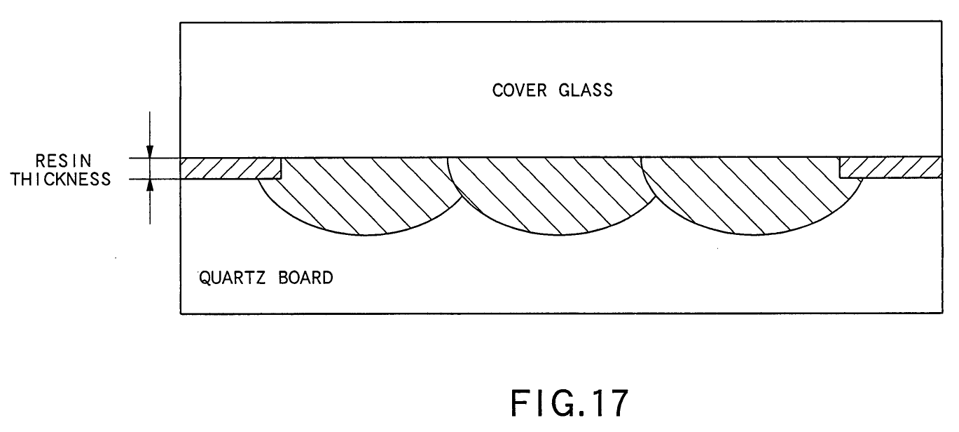

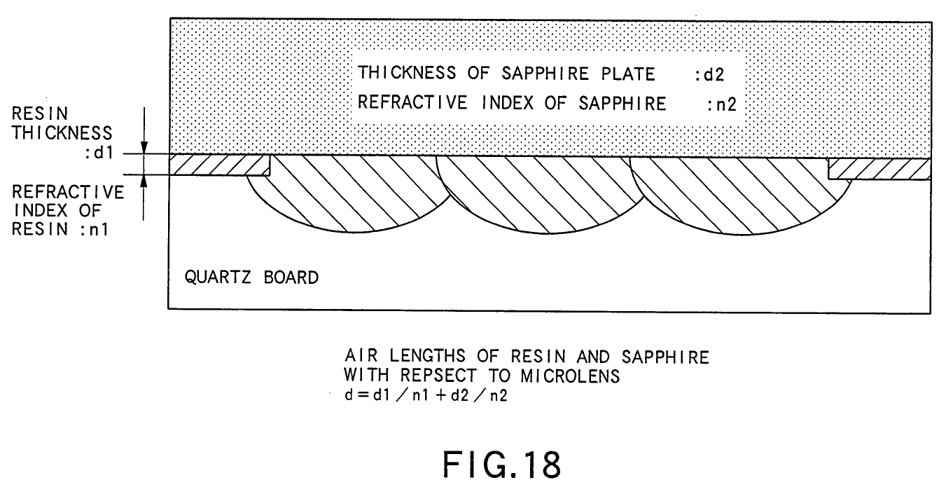

First, as in the case described with reference to FIG. 15, spherical surfaces each having a diameter substantially equal to the pixel size are formed at a spacing (between the centers of the spherical surfaces) equal to the pixel pitch, on a quarts substrate. Then, a resin having a refractive index of 1.60 is applied and extended by a spin coat technique, as shown in FIG. 17. In this case, the number of rotations and the rotation time are optimized so that the thickness shown as “resin thickness” in FIG. 17 becomes 10 μm. Then, as a cover glass, an optical compensation plate having a thickness greater than a predetermined thickness is prepared by the process shown in FIG. 9. The angle of inclination of the optical axis is 80° and the thickness of the sapphire substrate is approximately 35 μm.

The optical compensation plate is arranged at a position where it can optically compensate a pre-tilt component on the incidence side, and the optical compensation plate is attached to the microlens array. After that, the quartz glass and the sapphire plate are ground and polished to a predetermined thickness. In this case, the sapphire plate is ground and polished to a thickness of 12 μm, 16 μm, 20 μm, 24 μm and 28 μm.

Then, an ITO film is formed on the cover glass by a sputtering technique, thus preparing a microlens board.

In the liquid crystal panel, the microlens array is arranged on the incidence side, as in the above-described case. The liquid crystal panel is prepared, for example, in accordance with the following predetermined standard. Specifically, a liquid crystal cell of “XGA” standard having an effective pixel size (diagonal line) of 0.9 inches and a pixel pitch of 18 μm is prepared. Application of an orientation film, rubbing processing, and arrangement of a spacer are carried out at a rubbing angle of 90°, a twist angle of 90° and a cell gap of 3.2 μm, and liquid crystal (“MJ99200” (trade name) made by Merck Ltd.) is injected. The liquid crystal cell is thus completed.

Moreover, an optical compensation plate is prepared by the process shown in FIG. 9. The angle of inclination of the optical axis is 80° and the thickness of the sapphire substrate is approximately 30 μm.

The optical compensation plate is arranged at a position where it can optically compensate a pre-tilt component on the emission side, and the optical compensation plate is attached to the emission-side dustproof glass made of quartz. After that, the quartz glass and the sapphire plate are ground and polished to a predetermined thickness equal to the thickness of the cover glass on the microlens array. In this case, the sapphire plate is ground and polished to a thickness of 12 μm, 16 μm, 20 μm, 24 μm and 28 μm.

In this manner, the liquid crystal display device is completed as shown in FIG. 5. Each optical compensation plate is arranged in such a manner that the angle of inclination of the optical axis of the optical compensation plate on the luminous flux incidence side is equal to the angle of inclination of the optical axis of the optical compensation plate on the luminous flux emission side. In this case, the angle of inclination of the optical axis of the optical compensation plate for compensating a pre-tilt component on the luminous flux incidence side need not be coincident with the angle of inclination of the optical axis of the optical compensation plate for compensating a pre-tilt component on the luminous flux emission side.

Moreover, the flexible board 9 to be connected to the TFT board is attached and, for example, the metal frame 10 is fit thereon and the finishing plate 11 is attached, as shown in FIG. 12. The liquid crystal display device that can be used in the image display apparatus is thus completed.

For the liquid crystal display device formed as described above, the lightness ratio and contrast in the case of “white display” (without applying a voltage) of the image projected on the screen are measured in the case where the liquid crystal display devices have optical compensation plates and in the case where the liquid crystal display devices do not have optical compensation plates, using the optical system of the image display apparatus described with reference to FIG. 13. In the image display apparatus that acquired the following results, the F-value of the image forming lens of the optical system is 2.3.

Reference lightness is set in the case where the sapphire plate has a thickness of 20 μm. Not only the thickness of the sapphire plate but also the relation between the sum of the air lengths (optical path lengths) in the resin-thickness part and the sapphire plate and the lightness in the case of “white display” (without applying a voltage) are measured, as shown in FIG. 18. The air length (optical path length) is calculated by multiplying the thickness of a certain medium by its refractive index. In this case, the size of the image projected on the screen is set to be 40 inches in diagonal.

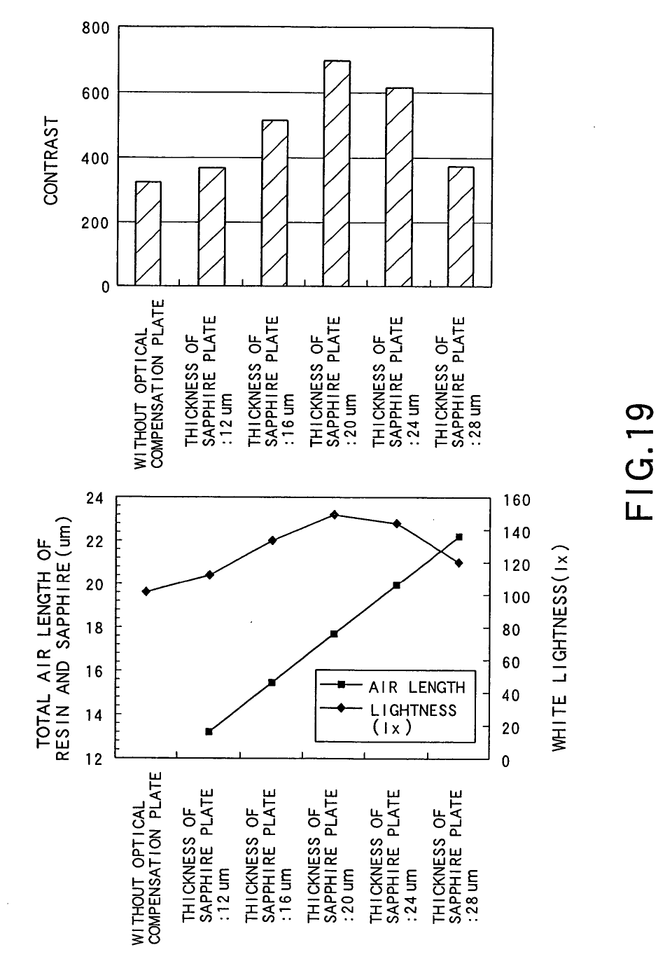

The results of the measurement show that in a liquid crystal panel having a pixel pitch of 14 μm and a diagonal line of 0.7 inches, when the sum of the air lengths of the resin and sapphire is approximately 18 μm, the lightness of white in “white display” (without applying a voltage) is almost at the maximum value and the maximum contrast is achieved, as shown in FIG. 19. By thus optimizing the conditions, it is possible to simultaneously achieve higher luminance and higher contrast of the displayed image.

[Preparation of Liquid Crystal Display Device (4)]

First, as in the case described with reference to FIG. 15, spherical surfaces each having a diameter substantially equal to the pixel size are formed at a spacing (between the centers of the spherical surfaces) equal to the pixel pitch, on a quarts substrate having a thickness of 1.5 mm. Then, a resin having a refractive index of 1.60 is applied and extended by a spin coat technique, as shown in FIG. 17. In this case, the number of rotations and the rotation time are optimized so that the thickness shown as “resin thickness” in FIG. 17 becomes 3 μm. Then, as a cover glass, an optical compensation plate having a thickness greater than a predetermined thickness is prepared by the process shown in FIG. 9. The angle of inclination of the optical axis is 80° and the thickness of the sapphire substrate is approximately 35 μm.

The optical compensation plate is arranged at a position where it can optically compensate a pre-tilt component on the incidence side, and the optical compensation plate is attached to the microlens array. After that, the quartz glass and the sapphire plate are ground and polished to a predetermined thickness. In this case, the sapphire plate is ground and polished to a thickness of 12 μm, 16 μm, 20 μm, 24 μm and 28 μm.

Then, an ITO film is formed on the cover glass by a sputtering technique, thus preparing a microlens board.

In the liquid crystal panel, the microlens array is arranged on the incidence side, as in the above-described case. The liquid crystal panel is prepared, for example, in accordance with the following predetermined standard. Specifically, a liquid crystal cell of “XGA” standard having an effective pixel size (diagonal line) of 0.9 inches and a pixel pitch of 18 μm is prepared. Application of an orientation film, rubbing processing, and arrangement of a spacer are carried out at a rubbing angle of 90°, a twist angle of 90° and a cell gap of 3.2 μm, and liquid crystal (“MJ99200” (trade name) made by Merck Ltd.) is injected. The liquid crystal cell is thus completed.

Moreover, an optical compensation plate is prepared by the process shown in FIG. 9. The angle of inclination of the optical axis is 80° and the thickness of the sapphire substrate is approximately 30 μm.

The optical compensation plate is arranged at a position where it can optically compensate a pre-tilt component on the emission side, and the optical compensation plate is attached to the emission-side dustproof glass made of quartz. After that, the quartz glass and the sapphire plate are ground and polished to a predetermined thickness equal to the thickness of the cover glass on the microlens array. In this case, the sapphire plate is ground and polished to a thickness of 12 μm, 16 μm, 20 μm, 24 μm and 28 μm.

In this manner, the liquid crystal display device is completed as shown in FIG. 5. Each optical compensation plate is arranged in such a manner that the angle of inclination of the optical axis of the optical compensation plate on the luminous flux incidence side is equal to the angle of inclination of the optical axis of the optical compensation plate on the luminous flux emission side. In this case, the angle of inclination of the optical axis of the optical compensation plate for compensating a pre-tilt component on the luminous flux incidence side need not be coincident with the angle of inclination of the optical axis of the optical compensation plate for compensating a pre-tilt component on the luminous flux emission side.

Moreover, the flexible board 9 to be connected to the TFT board is attached and, for example, the metal frame 10 is fit thereon and the finishing plate 11 is attached, as shown in FIG. 12. The liquid crystal display device that can be used in the image display apparatus is thus completed.

For the liquid crystal display device formed as described above, the lightness ratio and contrast in the case of “white display” (without applying a voltage) of the image projected on the screen are measured in the case where the liquid crystal display devices have optical compensation plates and in the case where the liquid crystal display devices do not have optical compensation plates, using the optical system of the image display apparatus described with reference to FIG. 13. In the image display apparatus that acquired the following results, the F-value of the image forming lens of the optical system is 2.3.

Reference lightness is set in the case where the sapphire plate has a thickness of 20 μm. Not only the thickness of the sapphire plate but also the relation between the sum of the air lengths (optical path lengths) in the resin-thickness part and the sapphire plate and the lightness in the case of “white display” (without applying a voltage) are measured, as shown in FIG. 18. The air length (optical path length) is calculated by multiplying the thickness of a certain medium by its refractive index. In this case, the size of the image projected on the screen is set to be 40 inches in diagonal.

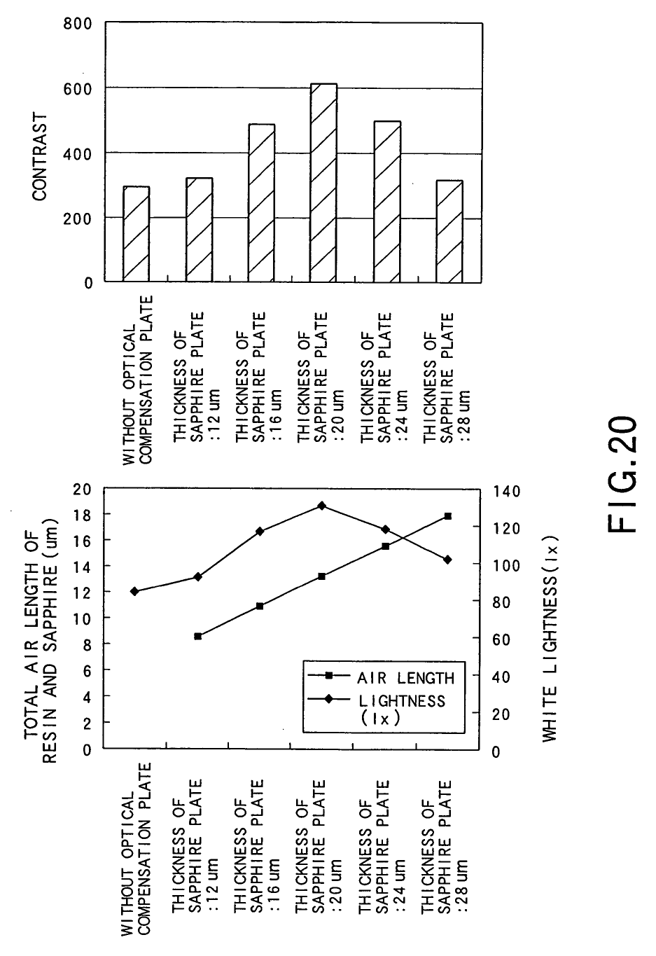

The results of the measurement show that in a liquid crystal panel having a pixel pitch of 11 μm and a diagonal line of 0.55 inches, when the sum of the air lengths of the resin and sapphire is approximately 13 μm, the lightness of white in “white display” (without applying a voltage) is almost at the maximum value and the maximum contrast is achieved, as shown in FIG. 20. By thus optimizing the conditions, it is possible to simultaneously achieve higher luminance and higher contrast of the displayed image.

As described above, in the image display apparatus using the liquid crystal display device as a spatial light modulator, higher luminance of a displayed image can be realized by the microlens array and the influence of a pre-tilt of liquid crystal molecules in the liquid crystal panel is optically compensated by the optical compensation layer. Higher contrast of the displayed image and a longer life of the apparatus are thus realized.

Moreover, in the image display apparatus according to this invention, higher luminance of a displayed image can be realized by the microlens array provided in the liquid crystal display device and the influence of a pre-tilt of liquid crystal molecules in the liquid crystal panel is optically compensated by the optical compensation layer, thus realizing higher contrast of the displayed image. Since a highly light-resistant inorganic material is used for the optical compensation layer, higher luminance of the displayed image can be realized by higher output of the light source of the image display apparatus. As the optical compensation layer is arranged along the liquid crystal panel surface, it does not increase the size of the apparatus. Moreover, if sapphire or crystal, which is highly thermally conductive, is used as the inorganic material, rise in the temperature of the liquid crystal display device can be restrained.

While the invention has been described in accordance with certain preferred embodiments thereof illustrated in the accompanying drawings and described in the above description in detail, it should be understood by those ordinarily skilled in the art that the invention is not limited to those embodiments, but various modifications, alternative constructions or equivalents can be implemented without departing from the scope and spirit of the present invention as set forth and defined by the appended claims.

1. A liquid crystal display device having a microlens array provided on a luminous flux incidence side,
the liquid crystal display device comprising an optical compensation layer made of an inorganic material and having an optical axis inclined with respect to a liquid crystal panel surface, at least on one of a luminous flux incidence side and a luminous flux emission side of the liquid crystal panel.

2-9. (canceled)

10. The liquid crystal display device as claimed in claim 1, wherein the optical compensation layer has an outer size equal to or larger than an effective display area of the liquid crystal panel.

11. The liquid crystal display device as claimed in claim 1, wherein the optical compensation layer is provided on a dustproof glass provided on the surface of the liquid crystal panel.

12. The liquid crystal display device as claimed in claim 1, wherein the optical compensation layer is provided on a cover glass of the microlens array.

13. A liquid crystal display device having a microlens array provided on a luminous flux incidence side,
the liquid crystal display device comprising two optical compensation layers made of an inorganic material and having an optical axis inclined with respect to a liquid crystal panel surface, on a luminous flux incidence side of the liquid crystal panel.

14. An image display apparatus comprising:
a light source;
a liquid crystal display device having a microlens array provided on a luminous flux incidence side as a spatial light modulator;
an illuminating optical system for guiding a luminous flux emitted from a light source to the liquid crystal display device and thus illuminating the liquid crystal display device; and
an image-forming lens for forming an image of the liquid crystal display device;
the liquid crystal display device having an optical compensation layer made of an inorganic material and having an optical axis inclined with respect to a liquid crystal panel surface, at least on one of a luminous flux incidence side and a luminous flux emission side of the liquid crystal panel.

15-22. (canceled)

23. The image display apparatus as claimed in claim 14, wherein the optical compensation layer of the liquid crystal display device has an outer size equal to or larger than an effective display area of the liquid crystal panel.

24. The image display apparatus as claimed in claim 14, wherein the optical compensation layer of the liquid crystal display device is provided on a dustproof glass provided on the surface of the liquid crystal panel.

25. The image display apparatus as claimed in claim 14, wherein the optical compensation layer of the liquid crystal display device is provided on a cover glass of the microlens array.

26. An image display apparatus comprising:
a light source;
a liquid crystal display device having a microlens array provided on a luminous flux incidence side as a spatial light modulator,
an illuminating optical system for guiding a luminous flux emitted from a light source to the liquid crystal display device and thus illuminating the liquid crystal display device; and
an image-forming lens for forming an image of the liquid crystal display device,
the liquid crystal display device having two optical compensation layers made of an inorganic material and having an optical axis inclined
